(19) United States
(12) Patent Application Publication
(10) Pub. No.: US 2016/0345165 A1
(43) Pub. Date: Nov. 24, 2016

(54) COLLECTING DATA FROM A STATISTICALLY SIGNIFICANT GROUP OF MOBILE DEVICES

(71) Applicant: QUALCOMM Incorporated, San Diego, CA (US)

(72) Inventors: Guilherme Luiz Karnas Hoefel, La Jolla, CA (US); Brian Fink, Ramona, CA (US); Michael William Paddon, Shinjuku-ku (JP); Craig Brown, Freshwater (AU); Vitor Carvalho, San Diego, CA (US)

(21) Appl. No.: 14/720,084

(22) Filed: May 22, 2015

(51) Int. Cl. H04W 8/24; H04L 29/08; H04W 24/08

(52) U.S. Cl. CPC H04W 8/24; H04W 24/08; H04L 67/22

(57) ABSTRACT

Methods, systems, and devices are described for wireless communication to enable data collection from wireless devices in an efficient manner. An aspect of the data collection approaches described herein may involve determining a smaller group of wireless devices from which to collect data. Determining the group may be performed such that the data collected is representative of the wireless devices as a whole. For example, a statistically significant group of wireless devices may be selected to be statistically representative of the wireless devices of the network. Various criteria may be identified for selecting the group. Such criteria may include a specified technique for selecting wireless devices for the group.

### BACKGROUND

1. Field of the Disclosure

The present disclosure, for example, relates to wireless communication systems, and more particularly to collecting data from wireless devices of such systems.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, space and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple wireless devices such as user equipments (UEs). Base stations may communicate with wireless communication devices on downstream links (e.g., downlink channels for transmissions from a base station to a UE) and upstream links (e.g., uplink channels for transmissions from a UE to a base station). Each base station has a coverage range, which may be referred to as the coverage area of a cell.

Understanding current and historical network operating conditions is important for deciding when and how to perform network upgrades, fixes, expansions, etc. Current approaches for collecting data regarding network operating conditions may be performed ad-hoc, such as performing data collection whenever a problem is encountered. Current approaches may be directed to collecting only network data, solely from network devices, and may not include data collection from wireless devices using the network. Where data may be collected from wireless devices on a network, the data collection may be hampered by bandwidth constraints.

### SUMMARY

The data collection approaches described herein involve collecting data from wireless devices generated during actual use of the network. The data from the wireless devices may be combined with network data, which may be collected using known techniques or by applying various features described herein, to build a historical map of wireless device and network usage, for example. One aspect of the data collection approaches may involve determining which wireless devices (e.g., from potentially thousands of wireless devices connected to the network) from which data should be collected. A statistically significant group of wireless devices may be selected to be statistically representative of the wireless devices of the network.

A method for wireless communication is described. The method may involve identifying criteria for selecting a statistically significant group of mobile devices from a plurality of mobile devices. The method also may involve selecting the statistically significant group in accordance with the criteria such that the statistically significant group is statistically representative of the plurality of mobile devices. Actual usage data may be collected from the mobile devices of the statistically significant group.

Identifying the criteria may involve determining a number of mobile devices to select for the statistically significant group. The number of mobile devices may be determined based at least in part on available bandwidth.

Selecting the statistically significant group may involve obtaining historical data of the plurality of mobile devices. The statistically significant group may be selected based at least in part on the obtained historical data.

Identifying the criteria may involve identifying that selection of the statistically significant group is to be at least partially random.

Identifying the criteria may involve identifying that selection of the statistically significant group is to use a furthest-first picking procedure. In such case, selecting the statistically significant group may involve: randomly selecting a first mobile device for the statistically significant group; selecting a second mobile device for the statistically significant group that is furthest from the first mobile device; and, selecting a subsequent mobile device for the statistically significant group that is furthest from previously selected mobile devices including the first and second mobile devices.

Alternatively or additionally, selecting the statistically significant group may involve applying the furthest-first picking procedure to a random subset of the plurality of mobile devices. In such case, the method also may involve identifying the random subset to include a first number of mobile devices that is less than a total number of devices of the plurality of mobile devices and greater than a second number of mobile devices to be selected for the statistically significant group.

Selecting the statistically significant group may involve dividing the plurality of mobile devices into a number of clusters. In such case, the method may involve selecting a mobile device nearest a center of each of the number of clusters for the statistically significant group.

Identifying the criteria may involve identifying that selection of the statistically significant group is to take into account characteristics of the plurality of mobile devices. Alternatively or additionally, identifying the criteria may involve identifying that selection of the statistically significant group is to take into account a variance of a metric among the plurality of mobile devices.

Collecting actual usage data from the mobile devices of the statistically significant group may be performed continuously. Alternatively, collecting actual usage data from the mobile devices of the statistically significant group may be performed opportunistically, such as based at least in part on one or more of available bandwidth, current amount of network traffic, historical amount of network traffic, current status of individual mobile devices of the statistically significant group, historical status of individual mobile devices of the statistically significant group, or a signal parameter.

An apparatus for wireless communication is described. The apparatus may include: means for identifying criteria for selecting a statistically significant group of mobile devices from a plurality of mobile devices; means for selecting the statistically significant group in accordance with the criteria such that the statistically significant group is statistically representative of the plurality of mobile devices; and, means for collecting actual usage data from the mobile devices of the statistically significant group. The apparatus may include these and other features to perform the various functions described above and further herein.

Another apparatus for wireless communication is described. The apparatus may include: a processor; memory in electronic communication with the processor; and, instructions stored in the memory. The instructions may be executable by the processor to cause the network device to: identify criteria for selecting a statistically significant group of mobile devices from a plurality of mobile devices; select the statistically significant group in accordance with the criteria such that the statistically significant group is statistically representative of the plurality of mobile devices; and, collect actual usage data from the mobile devices of the statistically significant group. The instructions may be executable by the processor to cause the network device to perform these and other features as described above and further herein.

A non-transitory computer-readable medium is described. The medium may store computer-executable code for wireless communication. The code may be executable by a processor to cause a device to: identify criteria for selecting a statistically significant group of mobile devices from a plurality of mobile devices; select the statistically significant group in accordance with the criteria such that the statistically significant group is statistically representative of the plurality of mobile devices; and, collect actual usage data from the mobile devices of the statistically significant group. The code may be executable by the processor to cause the device to perform these and other features as described above and further herein.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system, in accordance with various aspects of the present disclosure;

FIG. 2 shows a block diagram of a wireless communications system illustrating an approach for selecting a group of wireless devices for data collection, in accordance with various aspects of the present disclosure;

FIG. 3 shows a block diagram of a wireless communications system illustrating another approach for selecting a group of wireless devices for data collection, in accordance with various aspects of the present disclosure;

FIG. 4 shows a block diagram of a wireless communications system illustrating yet another approach for selecting a group of wireless devices for data collection, in accordance with various aspects of the present disclosure;

FIG. 5 illustrates an example of an operation and communication flow for selecting and collecting data from wireless devices, in accordance with various aspects of the present disclosure;

FIG. 6 shows a block diagram of an example of a device configured for use in wireless communication, in accordance with various aspects of the present disclosure;

FIG. 7 shows a block diagram of another example of a device configured for use in wireless communication, in accordance with various aspects of the present disclosure;

FIG. 8 shows a block diagram of a wireless communications system including a base station, in accordance with various aspects of the present disclosure;

FIG. 9 is a flow chart illustrating an example of a method for wireless communication, in accordance with various aspects of the present disclosure;

FIG. 10 is a flow chart illustrating another example of a method for wireless communication, in accordance with various aspects of the present disclosure; and

FIG. 11 is a flow chart illustrating yet another example of a method for wireless communication, in accordance with various aspects of the present disclosure.

### DETAILED DESCRIPTION

The data collection approaches described herein involve collecting data from wireless devices generated during actual use of a network. Because there may be thousands or even hundreds of thousands of wireless devices connected to the network, collecting data from the wireless devices may be challenging due to the amount of upstream bandwidth consumed by transfer of such data to the network. Further, collecting data from all wireless devices connected to the network may result in a large amount of data that may be inefficient to process.

An aspect of the data collection approaches described herein may involve determining a smaller group of wireless devices from which to collect data. Determining the group may be performed such that the data collected is representative of the wireless devices as a whole, or at least a type of wireless device used on the network. For example, a statistically significant group of wireless devices may be selected to be statistically representative of the wireless devices of the network. Various criteria may be identified for selecting the group. Such criteria may include a specified technique for selecting wireless devices for the group.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

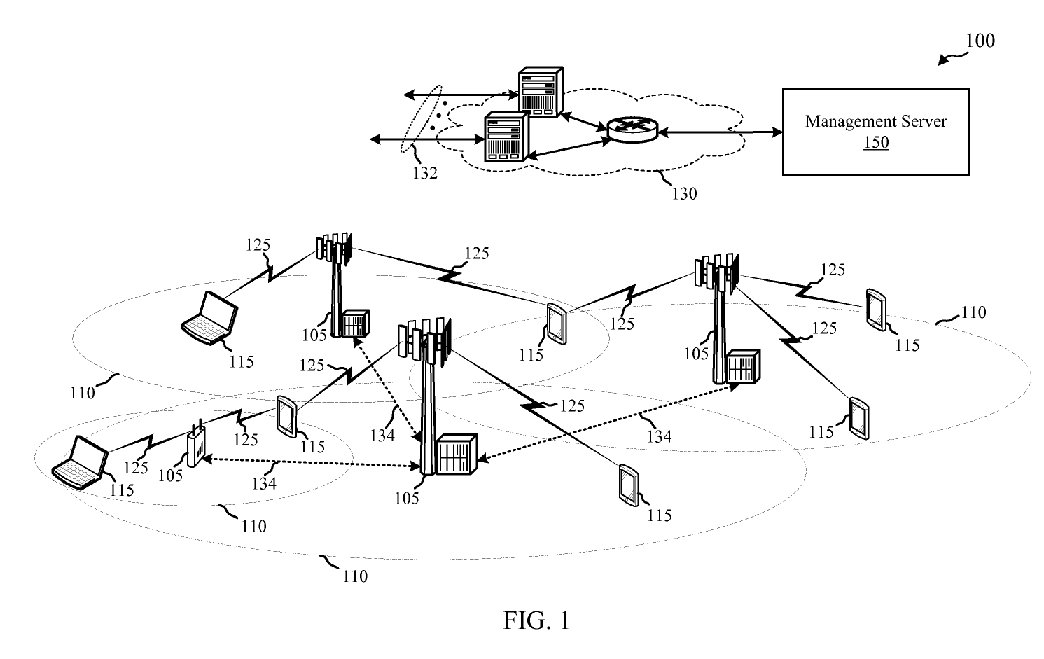

FIG. 1 illustrates an example of a wireless communications system 100 in accordance with various aspects of the disclosure. The wireless communications system 100 includes base stations 105, wireless devices 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the wireless devices 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the wireless devices 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro and/or small cell base stations). There may be overlapping geographic coverage areas 110 for different technologies.

In some examples, the wireless communications system 100 is a Long Term Evolution (LTE) or LTE-Advanced (LTE-A) network. In LTE/LTE-A networks, the term evolved Node B (eNB) may be generally used to describe the base stations 105, while the term user equipment (UE) may be generally used to describe the wireless devices 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a term used by an organization named “3rd Generation Partnership Project” (3GPP) to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The wireless devices 115 are dispersed throughout the wireless communications system 100, and each wireless device 115 may be stationary or mobile. A wireless device 115 may also include or be referred to by those skilled in the art as a mobile station, a subscriber station, a mobile unit, a subscriber unit, a wireless unit, a remote unit, a mobile device, a wireless communications device, a remote device, a mobile subscriber station, an access terminal, a mobile terminal, a wireless terminal, a remote terminal, a handset, a user agent, a UE, a mobile client, a client, or some other suitable terminology. A wireless device 115 may be a cellular phone, a personal digital assistant (PDA), a wireless modem, a wireless communication device, a handheld device, a tablet computer, a laptop computer, a cordless phone, a wireless local loop (WLL) station, or the like. A wireless device may be able to communicate with various types of base stations and network equipment including macro eNBs, small cell eNBs, relay base stations, and the like.

The communication links 125 shown in wireless communications system 100 may include uplink (UL) transmissions from a wireless device 115 to a base station 105, and/or downlink (DL) transmissions, from a base station 105 to a wireless device 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operations (e.g., using unpaired spectrum resources). Frame structures for FDD (e.g., frame structure type 1) and TDD (e.g., frame structure type 2) may be defined.

In some embodiments of the wireless communications system 100, base stations 105 and/or wireless devices 115 may include multiple antennas for employing antenna diversity schemes to improve communication quality and reliability between base stations 105 and wireless devices 115. Additionally or alternatively, base stations 105 and/or wireless devices 115 may employ multiple-input, multiple-output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A wireless device 115 may be configured with multiple downlink CCs and one or more uplink CCs for carrier aggregation. Carrier aggregation may be used with both FDD and TDD component carriers.

The wireless communications system 100 may include a management server 150 that may be connected to the base stations 105 (e.g., connected to a radio network associated with the base stations 105) through the core network 130. The management server 150 may receive information from the base stations 105 to perform various types of calculations, including but not limited to determining when and how to perform network upgrades, fixes, expansions, etc.

The base stations 105 of the network may facilitate collection of both network data and data from the wireless devices 115 connected to the network. As described above, collecting data from all of the wireless devices 115 connected to the network may be impractical (e.g., consumption of too much bandwidth, too much data to efficiently process, etc.). As such, the base stations 105 may determine a smaller, statistically significant group of the wireless devices 115 from which to collect data. Alternatively, a different network device, such as the management server 150, may make such determination. Thus, while the following description is presented in terms of a base station determining a statistically significant group, it should be understood that such description may apply to different network devices as well. Further details regarding determination of the group and collection of data are discussed below.

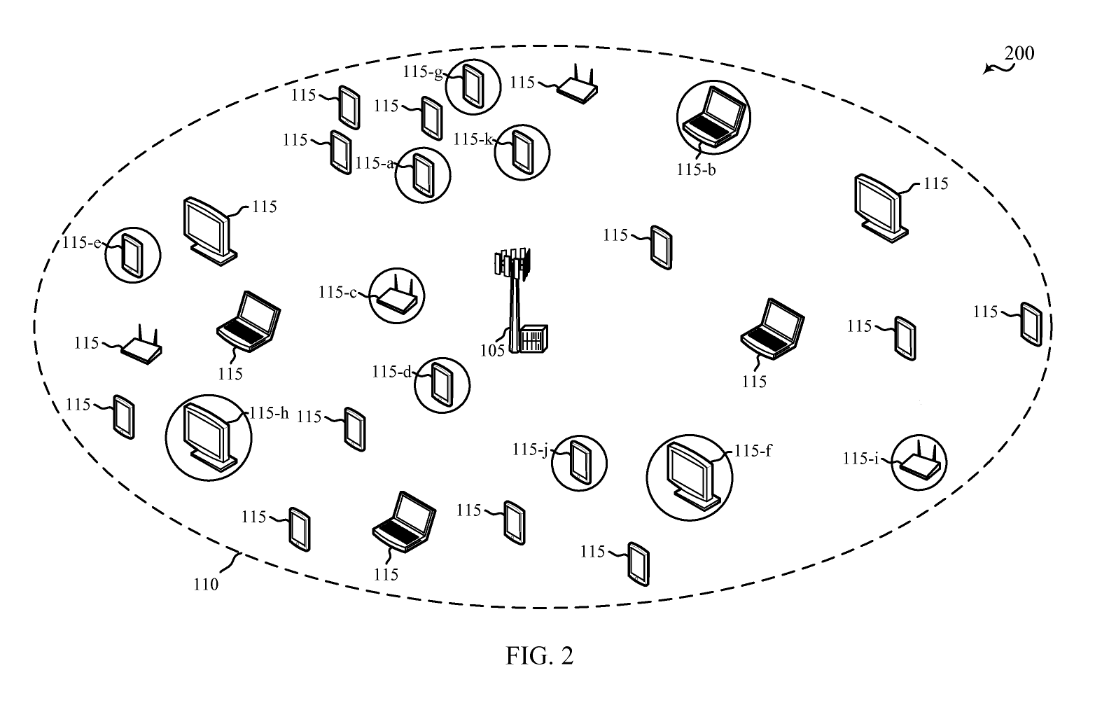

FIG. 2 shows a block diagram of a wireless communications system 200 illustrating an approach for selecting a group of wireless devices for data collection, in accordance with various aspects of the present disclosure. Initially, the base station 105 may identify a number k of wireless devices 115 to be selected for the group of devices from which to collect data. The number k should be less than a number n of wireless devices 115 located within a coverage area 110 of the base station 105, for example.

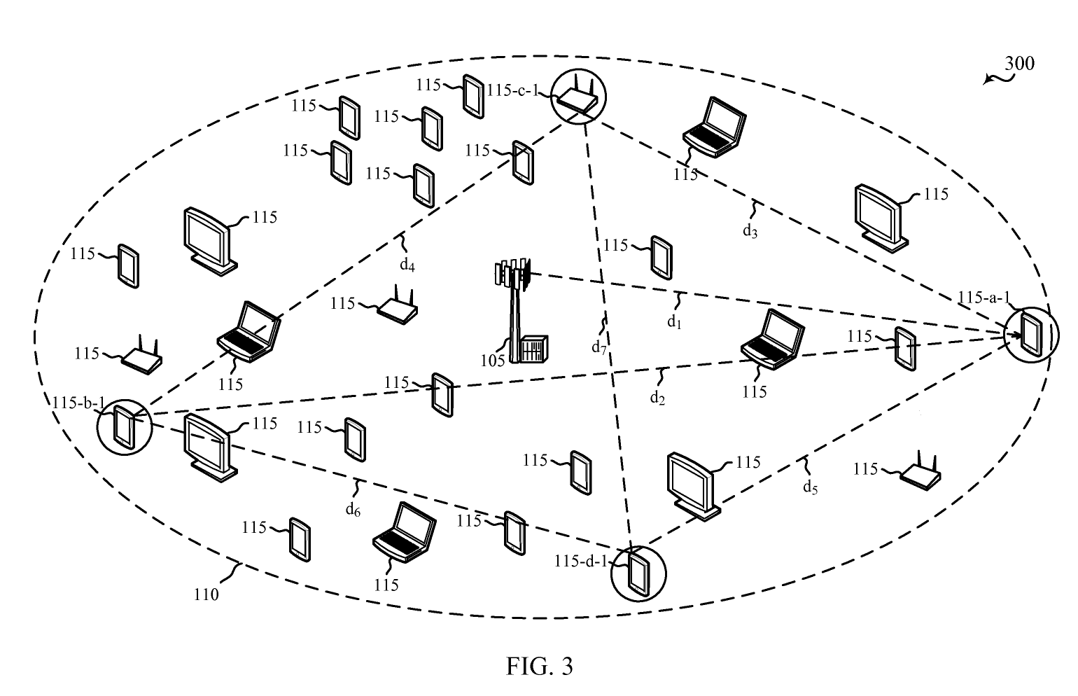

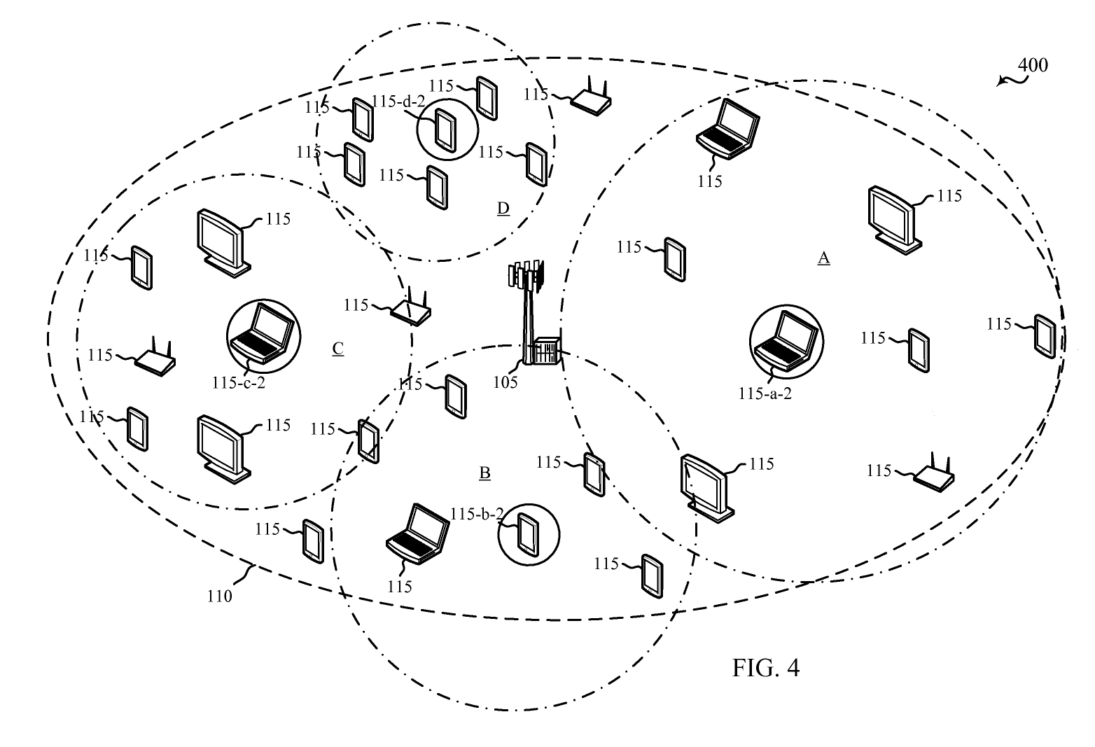

While the approach illustrated in FIG. 2 (as well as the approaches illustrated in FIGS. 3 and 4) is in terms of the coverage area 110 of the base station 105, it should be understood that an area of interest may be smaller or larger than the coverage area 110. For example, a portion of the coverage area 110, such as a sector or sectors (not shown), may be of interest, and the group of wireless devices selected for data collection may be from only those wireless devices located in the sector(s). Alternatively, an area of interest may include the coverage areas (and/or portions) of multiple base stations 105 (not shown) such that the group of wireless devices selected for data collection may be from only the wireless devices connected to the network and located in the area of interest.

The number k may be part of criteria for selecting a statistically significant group. The criteria may be determined by the base station 105, or by another network device such as the management server 150 of FIG. 1 and provided to the base station 105. The number k may be determined based on a bandwidth available within the coverage area 110. The bandwidth available may be an amount of bandwidth that will not significantly adversely affect overall performance of the network (e.g., experience of users of the wireless devices 115) when used for data collection. For example, the amount of bandwidth may be determined based on historical bandwidth usage within the coverage area 110, such as an average, mean, and/or peak bandwidth usage. Alternatively or additionally, the number k may be determined based on the total number n of wireless devices located within the coverage area. Additional or other factors that may be considered for determining k include: characteristics of the infrastructure covering the area of interest (e.g., network diversity, small cells versus regular cells, etc.); accuracy required to perform a task with the collected data; diversity of the wireless devices within the area of interest; time of day; etc.

Another criterion for selecting the group may be the technique to be employed for selecting, for example, when the base station 105 is configured to implement multiple different selection techniques. In such case, the criteria may specify which selection technique the base station is to use. Additional selection criteria may include a threshold amount of activity (e.g., traffic) of a wireless device 115, a threshold number of wireless devices located in a certain vicinity of a wireless device (e.g., to exclude outlying devices whose data could only represent themselves), geographic aspects of the area of interest, a geographic location of a wireless device, a type of wireless device, features of a wireless device, the manufacturer (e.g., the original equipment manufacturer (OEM)) of a wireless device, the power level and/or battery level of a wireless device, etc.

The technique for selecting the group illustrated in FIG. 2 may be referred to as a random selection technique. As described further herein, other techniques may be at least partially random and may involve some aspect of randomly selecting wireless devices. According to the random selection technique illustrated in FIG. 2, each of the k wireless devices 115 of the group may be selected randomly (e.g., entirely randomly after applying any other selection criteria).

As shown, the selection process may start by selecting a first wireless device 115-a at random. The selection process may continue by selecting a second wireless device 115-b, followed by selection of a third wireless device 115-c, and so on, until a kth wireless device 115-k is selected to achieve a selected group of k wireless devices 115. With a large enough total number n of wireless devices 115 in the coverage area 110, the random technique may result in selection of a statistically significant group that is statistically representative of wireless devices 115 in the coverage area 110.

FIG. 3. shows a block diagram of a wireless communications system 300 illustrating another approach for selecting a group of wireless devices for data collection, in accordance with various aspects of the present disclosure. Initially, as described above with respect to FIG. 2, the base station 105 may identify a number k of wireless devices 115 to be selected for the group of devices from which to collect data. Also as described above with respect to FIG. 2, the base station 105 may identify other criteria for selecting wireless devices for the group. In some cases, the criteria may specify a selection technique, which may be employed either before or after other selection criteria are applied.

The technique for selecting the group illustrated in FIG. 3 may be referred to as a furthest-first selection technique. As described further herein, other techniques may be at least partially furthest-first based and may involve some aspect of selecting wireless devices in a furthest-first manner. According to the furthest-first selection technique illustrated in FIG. 3, each of the k wireless devices 115 of the group may be selected based on location, for example, distance of non-selected wireless devices from previously-selected wireless devices.

As shown, the selection process may start by selecting a first wireless device 115-a-1 that is located furthest from the base station 105. The first selected wireless device 115-a-1 may be a distance d₁ that is greater than any other distance between the base station 115 and another wireless device within the coverage area 110. Alternatively, in some cases selecting the first wireless device 115-a-1 may be at random.

The selection process may continue by selecting a second wireless device 115-b-1 that is located furthest from the first selected wireless device 115-a-1. The second selected wireless device 115-b-1 may be a distance d₂ that is greater than any other distance between the first selected wireless device 115-a-1 and another wireless device within the coverage area 110. Although not illustrated, in some cases the distance from the base station 105 may also be considered for selecting the second selected wireless device 115-b-1.

The selection process may continue by selecting a third wireless device 115-c-1 that is located furthest from both the first selected wireless device 115-a-1 and the second selected wireless device 115-b-1. The third selected wireless device 115-c-1 may be a distance d₃ from the first selected wireless device 115-a-1 and a distance d₄ from the second selected wireless device 115-b-1. The combined distance d₃ plus d₄ may be greater than combined distances of any other wireless device 115 from the first selected wireless device 115-a-1 and the second selected wireless device 115-b-1.

The selection process may continue by selecting a fourth wireless device 115-d-1 that is located furthest from each of the first selected wireless device 115-a-1, the second selected wireless device 115-b-1 and the third selected wireless device 115-c-1. The fourth selected wireless device 115-c-1 may be a distance d₅ from the first selected wireless device 115-a-1, a distance d₆ from the second selected wireless device 115-b-1 and a distance d₇ from the third selected wireless device 115-c-1. The combined distance d₅ plus d₆ plus d₇ may be greater than combined distances of any other wireless device 115 from the first selected wireless device 115-a-1, the second selected wireless device 115-b-1 and the third selected wireless device 115-c-1.

The selection process may be complete at this point, in the case of k equal to four (4). Otherwise, the selection process may continue in accordance with the foregoing until the k wireless devices are selected for the group. For the sake of simplicity and clarity in FIG. 3, the selection process is not illustrated for k greater than four (4). By selecting wireless devices based on relative location, the furthest-first selection technique may result in selection of a statistically significant group that is statistically representative of wireless devices 115 in the coverage area 110.

Another furthest-first technique may involve initially selecting a random subset of the wireless devices 115 within the coverage area 110. Then, a furthest-first picking or selection procedure, such as described above, may be applied to the random subset. Thus, this alternative technique also may result in selection of a statistically significant group that is statistically representative of wireless devices 115 in the coverage area 110.

FIG. 4. shows a block diagram of a wireless communications system 400 illustrating yet another approach for selecting a group of wireless devices for data collection, in accordance with various aspects of the present disclosure. Initially, as described above with respect to FIG. 2, the base station 105 may identify a number k of wireless devices 115 to be selected for the group of devices from which to collect data. Also as described above with respect to FIG. 2, the base station 105 may identify other criteria for selecting wireless devices for the group. In some cases, the criteria may specify a selection technique, which may be employed either before or after other selection criteria are applied.

The technique for selecting the group illustrated in FIG. 4 may be referred to as a cluster selection technique. As described further herein, other techniques may be at least partially cluster based and may involve some aspect of selecting wireless devices using clusters. According to the cluster selection technique illustrated in FIG. 4, each of the k wireless devices 115 of the group may be selected based on an initial identification, determination or selection of clusters.

As shown, the selection process may start by dividing the wireless devices 115 within the coverage area 110 into a plurality of clusters A, B, C and D. Although four (4) clusters are shown in FIG. 4 for the sake of simplicity and clarity, it should be understood that the wireless devices 115 may be divided into any suitable number of clusters. The clusters may or may not include all of the wireless devices 115 in the coverage area 110 (as shown). Alternatively, the dividing of the wireless devices 115 into clusters may be performed such that each of the wireless devices 115 within the coverage area belong to at least one or only one cluster. The clusters may be defined to include a same number of the wireless devices 115 as each other, or may include different numbers of the wireless devices 115 (e.g., as shown). Further, the clusters may be defined to include a same amount of the coverage area 110, or different amounts. In some cases, the clusters may be defined by sectors of the coverage area (not shown).

The selection process may continue by selecting a first wireless device 115-a-2 from the cluster A. The first selected wireless device 115-a-2 may be the wireless device in the cluster A that is located at or nearest to a center of the cluster A. Alternatively, the first selected wireless device 115-a-2 may be selected randomly from among the wireless devices in the cluster A.

The selection process may continue by selecting a second wireless device 115-b-2 from the cluster B, a third selected wireless device 115-c-2 from the cluster C and a fourth wireless device 115-d-2 from the cluster D. The selection process may be complete at this point, in the case of k equal to four (4) and four (4) clusters being defined. Otherwise, the selection process may continue in accordance with the foregoing until the k wireless devices are selected for the group. For the sake of clarity in FIG. 3, the selection process is not illustrated for k greater than four (4). By selecting wireless devices based on clusters, the cluster technique may result in selection of a statistically significant group that is statistically representative of wireless devices 115 in the coverage area 110.

Although not illustrated, in some cases the number of wireless devices 115 selected from the clusters may be more than one. The number of wireless devices 115 selected from each cluster may be the same or different. For example, the number of wireless devices 115 selected from a particular cluster may depend on a size of the cluster (e.g., area encompassed by the cluster and/or number of wireless devices 115 in the cluster).

Additional or other techniques may be used for sampling k. Using a k-means-like initialization procedure assumes that (1) all wireless devices are created equal (except for their location) and (2) wireless devices in close proximity to each other have “similar” values of data that is to be collected. This may not always be the case. Thus, the characteristics of the wireless devices in the area of interest may be taken into account for selection of devices for the statistically significant group.

Different types of inferences or surveillances may benefit from different strategies for sampling. For instance, if the goal is to monitor the power received in a specific region (e.g., behind a small hill), targeting that geographic region (e.g., selecting more wireless devices located in that region for data collection or requesting more data from wireless devices in that region) may be beneficial. Other regions covered by the same cell then may be less represented by the sampling or even ignored.

From a statistical sampling perspective, a better inference (e.g., faster convergence/stronger statistical significance) may be achieved by sampling more points from regions of higher variance of a particular metric (or sampling less in regions of low variance of the metric). Several techniques may be employed to implement such an approach, including stratified sampling, importance sampling, and other variance sampling techniques.

The selection criteria may specify such additional details, as appropriate or desired.

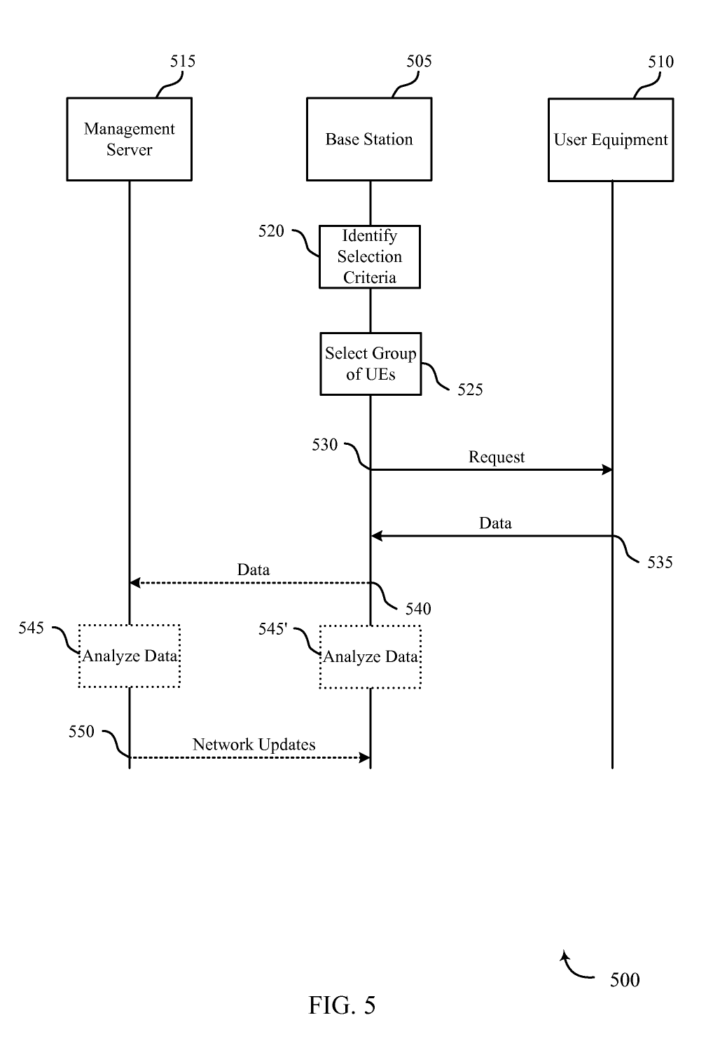

FIG. 5. illustrates an example of an operation and communication flow 500 for selecting and collecting data from wireless devices, in accordance with various aspects of the present disclosure. Flow 500 may involve a base station 505 and a UE 510. Although a plurality of UEs may be involved in practice, the single UE 510 is illustrated in FIG. 5 for the sake of simplicity and clarity. Flow 500 also may involve a management server 515 or other network entity. The base station 505 may be an example of aspects of the base stations 105 illustrated in FIGS. 1-4. The UE 510 may be an example of aspects of the wireless devices 115 illustrated in FIGS. 1-4. The management server 515 may be an example of aspects of the management server 130 of FIG. 1.

At block 520, the base station 505 may identify criteria for selecting a statistically significant group of UEs 510 from a plurality of UEs 510 within an area of interest (e.g., a coverage area of the base station 505). The base station 505 may identify the selection criteria by determining the selection criteria itself, and/or by receiving the selection criteria from the network (e.g., from the management server 515). As described herein, the selection criteria may include various criteria, such as a number k of UEs to be selected for the group, a selection technique to employ, etc.

Next, at block 525, the base station 505 may apply the identified selection criteria to select the statistically significant group of UEs 510. Any of the techniques described herein, or techniques involving combinations of the features thereof, may be used at block 525.

Once the group of UEs 510 has been selected, the base station 505 may communicate with the selected UEs 510 for data collection. For example, at 530 the base station 505 may send a request to one or more of the selected UEs 510 to obtain data collected at the respective UE(s) 510. Such a request may be sent periodically, opportunistically (e.g., based on network conditions and/or status of the respective UE(s) 510), or only once to inform the selected UEs 510 that they are to report data to the network (e.g., via the base station 505) either periodically, opportunistically or continuously. When the request at 530 informs the selected UEs 510 to report data, the selected UEs 510 may perform such reporting without receiving further requests (e.g., until the base station 505 informs the selected UE(s) 510 to no longer report data, as in the case where a different group of UEs 510 has been selected for data collection).

In any case, at 535, the selected UE(s) 510 may respond to the request by sending data to the base station 505. Such data may include but is not limited to: power measurements, strengths of signals, error rates, time delays, buffering, transmission rates (e.g., data rates), application usage, visible base stations, power consumption, geo-position or other location information, interference, quality indicators, resource usage, connectivity, and/or other information that may only be available at the selected UE(s) 510 (e.g., not available to the network).

Optionally, as represented by dashed lines, at 540 the base station 505 may send the data received from the selected UE(s) 510 to the management server 515. At block 545, the management server 515 may analyze the received data. Based at least in part on such analysis, the management server 515 may determine that certain actions may be taken, such as to fix a problem, improve service, increase capacity, etc. Then, at 550 the management server 515 may communicate suitable network updates to the base station 505 for implementation.

Alternatively, the base station 505 itself may analyze the data received from the selected UE(s) 510, as also represented by dashed lines at block 545′. In such case, the base station 505 may report results of such analysis to the network (e.g., to the management server 515) so that appropriate action may be determined (e.g., when the base station 505 is not configured to address a particular issue, such as increasing capacity).

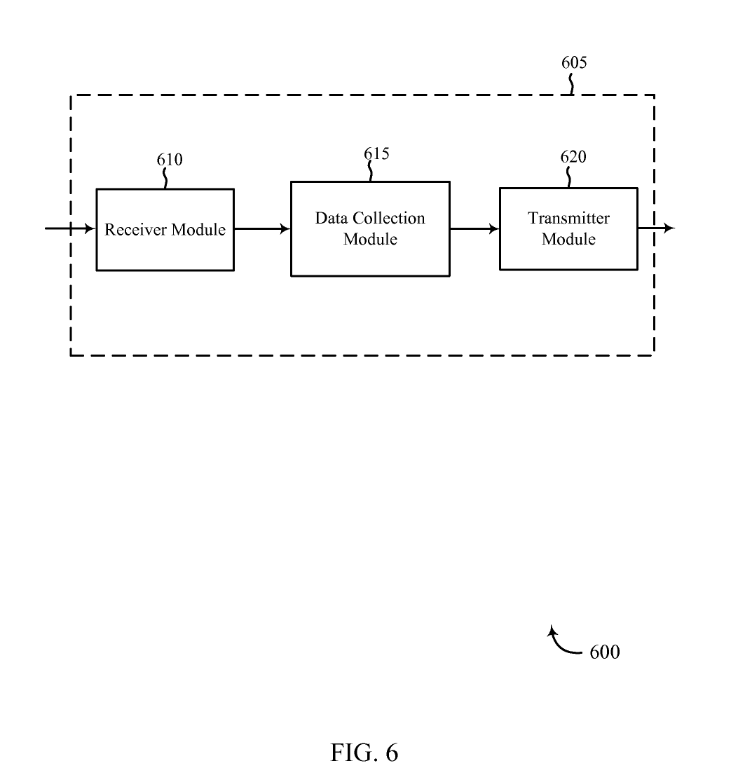

FIG. 6 shows a block diagram 600 of a device 605 for use in a base station for wireless communication, in accordance with various aspects of the present disclosure. The device 605 may be an example of one or more aspects of the base stations 105 described with reference to FIGS. 1-4 and one or more aspects of the base station 505 described with reference to FIG. 5. The device 605 may include a receiver module 610, a data collection module 615, and/or a transmitter module 620. The device 605 may also be or include a processor (not shown). Each of these modules may be in communication with each other.

The device 605, through the receiver module 610, the data collection module 615, and/or the transmitter module 620, may be configured to perform functions described herein. For example, the device 605 may be configured to identify criteria for selecting a statistically significant group of wireless devices, select the group in accordance with the identified criteria, and collect actual usage data from the wireless devices of the group.

The modules of the device 605 (and those of the related devices described below) may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The receiver module 610 may receive information such as packets, user data, and/or control information associated with various information channels (e.g., control channels, data channels, etc.). The receiver module 610 may be configured to receive actual usage data from wireless devices. Such information may be passed on to the data collection module 615, and to other components of the device 605.

The data collection module 615 may collect data from wireless devices as described herein. In order to carry out such functionality, the data collection module 615 may determine or otherwise identify criteria to select a statistically significant group of wireless devices. The data collection module 615 may consider a variety of factors (e.g., available bandwidth, total number of wireless devices within the area of interest, the layout/locations of such wireless devices, the topography (e.g., land and/or buildings) of the area of interest, etc.) to determine the selection criteria. In some cases, the data collection module 615 may receive, via the receiver module 610, at least some of the selection criteria from the network.

Further, the data collection module 615 may perform selection of the statistically significant group of wireless devices in accordance with the selection criteria, including but not limited to a number k of wireless devices to select and a technique to be employed for the selection. As described with respect to FIG. 5, for example, the data collection module 615 may inform, via the transmitter module 620, the selected wireless devices of the group that they are to report data to the network (e.g., to the device 605) and how they should perform such reporting (e.g., continuously, periodically, opportunistically, etc.). Alternatively, the data collection module 615 may request, via the transmitter module 620, data from the selected wireless devices (e.g., periodically, opportunistically, etc.), and receive the requested data from the selected wireless devices via the receiver module 610.

In some cases, the data collection module 615 may be configured to analyze the received data. Alternatively, the device 605 may include an analysis module (not shown) to perform such analysis. The data collection module 615 (or the analysis module) may determine some action to take based at least in part on a result of the analysis, and may carry out such action (if the device 605 is configured to do so) or request that a network device (e.g., the management server 150, 515 described with reference to FIGS. 1 and 5) carry out the action.

The transmitter module 620 may transmit the one or more signals received from other components of the device 605. The transmitter module 620 may transmit the data received from wireless devices and/or results from analysis of such data. In some examples, the transmitter module 620 may be collocated with the receiver module 610 in a transceiver module.

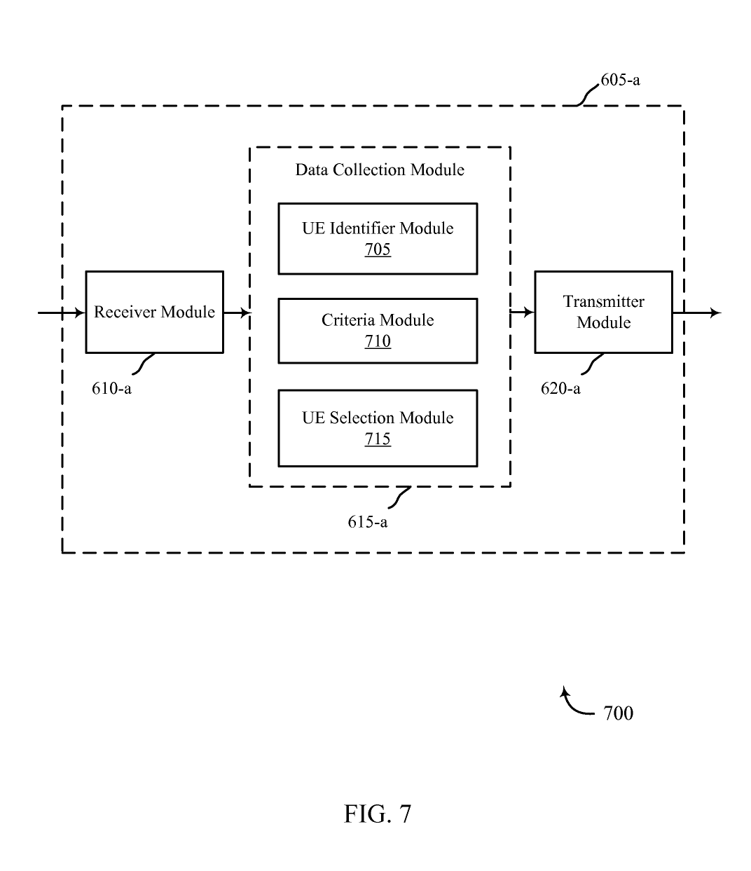

FIG. 7 shows a block diagram 700 of a device 605-a for use in a base station for wireless communication, in accordance with various examples. The device 605-a may be an example of one or more aspects of the base stations 105 described with reference to FIGS. 1-4 and the base station 505 described with reference to FIG. 5. The device 605-a also may be an example of the device 605 described with reference to FIG. 6. The device 605-a may include a receiver module 610-a, a data collection module 615-a, and/or a transmitter module 620-a, which may be examples of the corresponding modules of device 605. The device 605-a may also include a processor (not shown). Each of these modules may be in communication with each other. The receiver module 610-a and the transmitter module 620-a may perform the functions of the receiver module 610 and the transmitter module 620, of FIG. 6, respectively.

The data collection module 615-a may include a UE identifier module 705, a criteria module 710 and a UE selection module 715. The UE identifier module 705 may identify each of the UEs located within a coverage area of the associated base station. Such identification may be performed as part of a registration process of each UE with the base station, for example. Each UE may be identified by any suitable identifier, such as a Medium Access Control (MAC) address, an International Mobile Subscriber Identity (IMSI), an International Mobile Equipment Identity (IMEI), etc. In some cases, the UE identifier module 705 also may be configured to obtain and associate location information (e.g., geo-position, such as Global Positioning (GPS) coordinates, or any suitable information that indicates relative locations of the UEs to the base station and/or each other.

The criteria module 710 may perform various operation to identify criteria for selection of UEs for a statistically significant group from which to collect data. The criteria module 710 may determine the criteria based on various information regarding the network, the coverage area, and/or the UEs located within the area of interest. Alternatively or additionally, as discussed herein, the criteria module 710 may receive the criteria from another device of the network (e.g., the management server 150, 515 described with respect to FIGS. 1 and 5). For example, the area of interest may be determined by the network, while the device 605-a may have information specific to the area of interest to determine other selection criteria. As described herein, the criteria module 710 may identify the criteria to be applied for selecting the UEs for the group, such as the number k of UEs to be selected and the technique to be employed.

The UE selection module 715 may receive the identified criteria from the criteria module 710 and perform selection of UEs for the group in accordance with such criteria. As described herein, the UE selection module 715 may be configured to perform more than one selection technique. Thus, the UE selection module 715 may perform various operations according to the selection technique being employed, such as those described herein.

Once the statistically significant group of UEs has been selected, the device 605-a may perform data collection such as described above with reference to the device 605 of FIG. 6. Optionally, the device 605-a may be configured to analyze the data collected from the selected UEs, and/or to perform various actions based on a result of such analysis. The device 605-a may include additional modules, as appropriate or desired, to carry our such additional operations. However, the details of such additional modules may be implementation specific, and therefore are not described further herein.

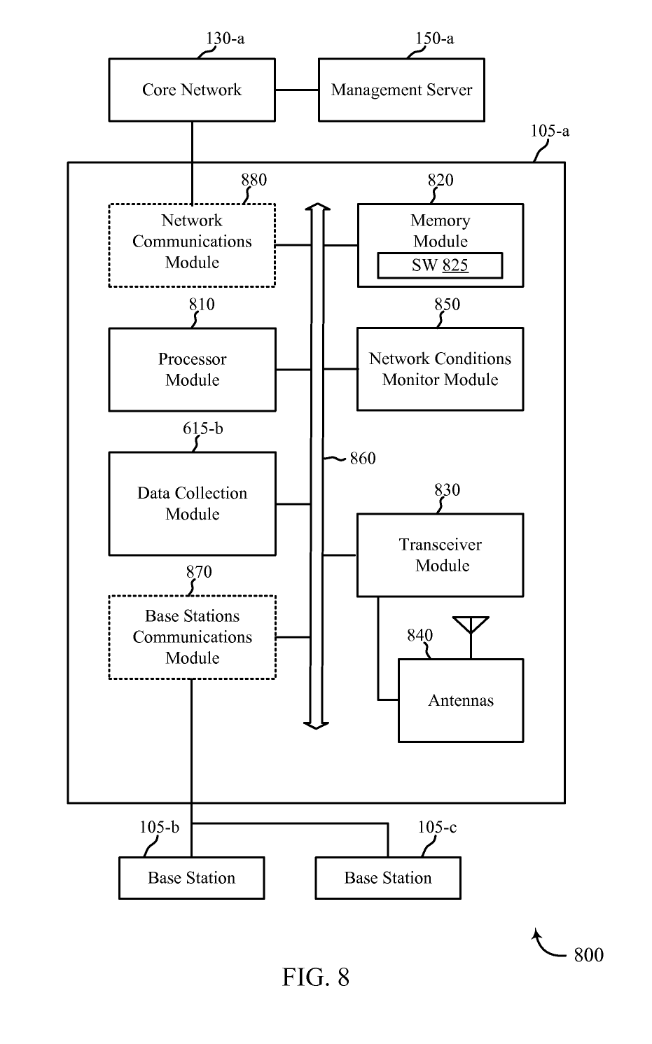

Turning to FIG. 8, a block diagram 800 is shown that illustrates a base station 105-a configured for data collection from wireless devices. In some aspects, the base station 105-a may be an example of aspects of the base stations 105, 505 described with reference to FIGS. 1-5. The base station 105-a also may be an example of the devices 605, 605-a described with reference to FIGS. 6 and 7. The base station 105-a may include a processor module 810, a memory module 820, a transceiver module(s) 830, an antenna(s)s 840, and a data collection module 615-b. The data collection module 615-b may be an example of aspects of the data collection modules 615, 615-a described with reference to FIGS. 6 and 7. The base station 105-a further may include a network conditions monitor module 850. In some examples, the base station 105-a also may include one or both of a base stations communications module 960 and a network communications module 970. Each of these modules may be in communication with each other, directly or indirectly, over at least one bus 860.

The memory module 820 may include random access memory (RAM) and read-only memory (ROM). The memory module 820 may also store computer-readable, computer-executable software (SW) code 825 containing instructions that are configured to, when executed, cause the processor module 810 to perform various functions described herein for data collection from wireless devices, for example. Alternatively, the software code 825 may not be directly executable by the processor module 810 but be configured to cause the computer, e.g., when compiled and executed, to perform functions described herein.

The processor module 810 may include an intelligent hardware device, e.g., a central processing unit (CPU), a microcontroller, an ASIC, etc. The processor module 810 may process information received through the transceiver module(s) 830, the base stations communications module 870, and/or the network communications module 880. The processor module 810 may also process information to be sent to the transceiver module(s) 830 for transmission through the antenna(s) 840, to the base stations communications module 870, and/or to the network communications module 880. The processor module 810 may handle, alone or in connection with the data collection module 615-b, various aspects related to identifying criteria for selecting a statistically significant group of wireless devices, selecting the group in accordance with the identified criteria, and collect actual usage data from the wireless devices of the group.

The transceiver module(s) 830 may include a modem configured to modulate the packets and provide the modulated packets to the antenna(s) 840 for transmission, and to demodulate packets received from the antenna(s) 840. The transceiver module(s) 830 may be implemented as at least one transmitter module and at least one separate receiver module. The transceiver module(s) 830 may be configured to communicate bi-directionally, via the antenna(s) 840, with at least one wireless device 115 as illustrated in FIGS. 1-4, for example. The base station 105-a may typically include multiple antennas 840 (e.g., an antenna array). The base station 105-a may communicate with a core network 130-a through the network communications module 880. The base station 105-a may communicate with other base stations, such as the base station 105-b and the base station 105-c, using the base stations communications module 870.

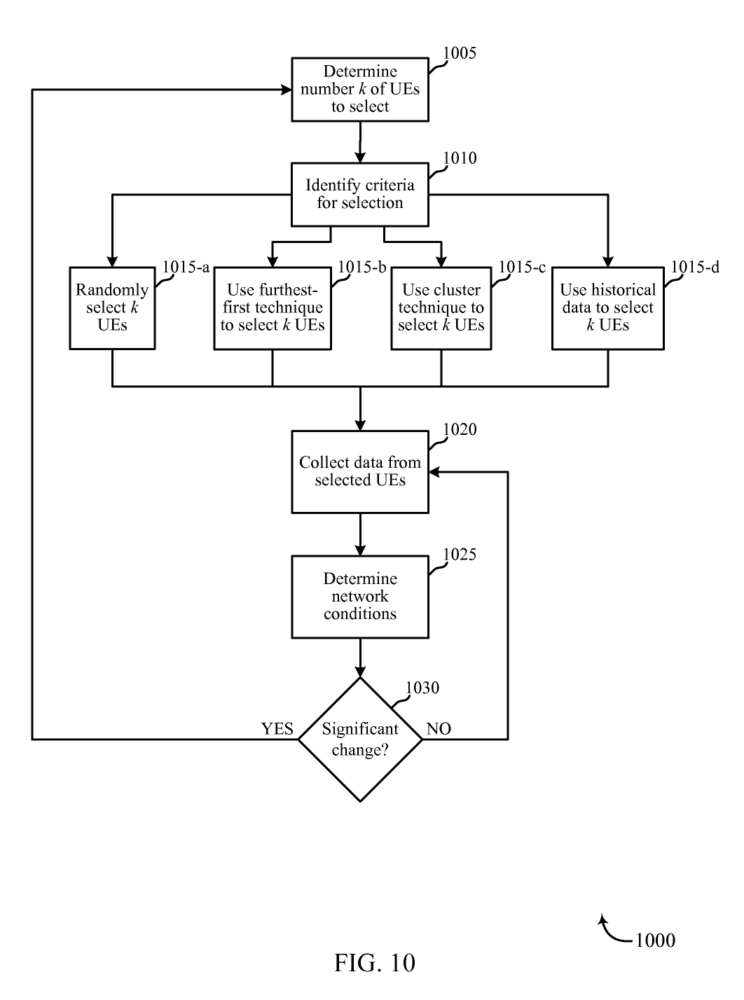

The network conditions monitor module 850 may monitor network conditions on an ongoing basis. Alternatively or additionally, the network conditions monitor module 850 may receive updates regarding conditions from the network (e.g., from the management server 150-a via the core network 130-a and the network communications module 880). As described further with reference to FIG. 10, the network conditions may be used to determine when to repeat the process of selecting a statistically significant group of wireless devices, so that the wireless devices data is collected from remain statistically representative of the wireless devices located within the area of interest (e.g., the coverage area of the base station 105-a).

Although not illustrated in the architecture of FIG. 8, the base station 105-a further may include a communications management module, which may manage communications with wireless devices 115 and/or other wireless devices as illustrated in the wireless communications system/network 100 of FIG. 1. The communications management module may be in communication with some or all of the other modules of the base station 105-a via the bus or buses 860. Alternatively, functionality of the communications management module may be implemented as a component of the transceiver module(s) 830, as a computer program product, and/or as at least one controller element of the processor module 810.

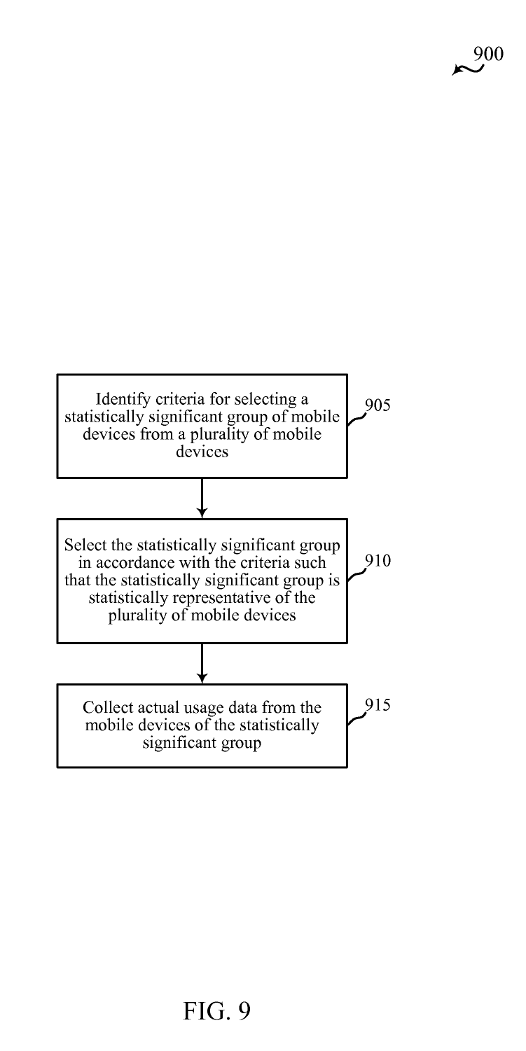

The modules of the base station 105-a may be configured to implement aspects discussed above with respect FIGS. 1-7, and those aspects may not be repeated here for the sake of brevity. Moreover, the modules of the base station 105-a may be configured to implement aspects discussed below with respect to FIGS. 9-11 and those aspects may not be repeated here also for the sake of brevity.

FIG. 9 is a flow chart illustrating an example of a method 900 for wireless communication, in accordance with various aspects of the present disclosure. For clarity, the method 900 is described below with reference to aspects of one or more of the base stations 105, 505 described with reference to FIGS. 1-5 and 8, and/or aspects of one or more of the devices 605 described with reference to FIGS. 6 and 7. In some examples, a base station may execute one or more sets of codes to control the functional elements of the base station to perform the functions described below. Additionally or alternatively, the base station may perform one or more of the functions described below using special-purpose hardware.

At block 905, the method 900 may involve identifying criteria for selecting a statistically significant group of mobile devices from a plurality of mobile devices. As described herein, the plurality of mobile devices may be located in an area of interest (e.g., a coverage area of a base station). The operation(s) at block 905 may be performed using the data collection module 615 described with reference to FIGS. 6-8.

Next, at block 910, the statistically significant group may be selected in accordance with the criteria such that the statistically significant group is statistically representative of the plurality of mobile devices. For example, the selection criteria identified at block 905 may include, among other criteria, a number k of mobile devices to select and a technique to use for selecting the k mobile devices. The operation(s) at block 910 also may be performed using the data collection module 615 described with reference to FIGS. 6-8.

Then, at block 915, actual usage data may be collected from the mobile devices of the statistically significant group. The operation(s) at block 915 also may be performed using the data collection module 615 described with reference to FIGS. 6-8.

Thus, the method 900 may provide for data collection from a group of mobile devices in an efficient manner. It should be noted that the method 900 is just one implementation and that the operations of the method 900 may be rearranged or otherwise modified such that other implementations are possible.

FIG. 10 is a flow chart illustrating another example of a method 1000 for wireless communication, in accordance with various aspects of the present disclosure. For clarity, the method 1000 is described below with reference to aspects of one or more of the base stations 105, 505 described with reference to FIGS. 1-5 and 8, and/or aspects of one or more of the devices 605 described with reference to FIGS. 6 and 7. In some examples, a base station may execute one or more sets of codes to control the functional elements of the base station to perform the functions described below. Additionally or alternatively, the base station may perform one or more of the functions described below using special-purpose hardware.

At block 1005, the method 1000 may involve determining a number k of UEs to select for data collection. In some cases, block 1005 may involve receiving an indication (e.g., an instruction) from the network of how many UEs to select. In such case, the operation(s) at block 1005 may be performed using the data collection module 615 in conjunction with the receiver module 610 or the transceiver module 830 described with reference to FIGS. 6-8.

At block 1010, criteria may be identified for selecting a statistically significant group of UEs devices from a plurality of UEs. As described herein, the plurality of UEs may be located in an area of interest (e.g., a coverage area of a base station). Such criteria identification may involve determining or selecting criteria to apply to the UE selection process. Alternatively, the criteria identification may involve receiving an indication (e.g., an instruction) from the network regarding the criteria to apply. Thus, the operation(s) at block 1010 may be combined with the operation(s) at block 1005, but are illustrated as separate blocks as an example. The operation(s) at block 1010 may be performed using the data collection module 615 described with reference to FIGS. 6-8.

Among the criteria identified at block 1010 may be a specific technique to be used for selecting the UEs for the group. In such case, the method 1000 may proceed to one of blocks 1015-a, 1015-b, 1015-c or 1015-d according to the specific technique. As shown in FIG. 10, block 1015-a may involve randomly selecting k UEs for the group. Block 1015-b may involve using a furthest-first technique to select k UEs for the group, such as a strict furthest-first technique, or a random/furthest-first technique (e.g., randomly selecting a first UE and/or randomly selecting a subset of UEs and then proceeding with furthest-first selection). Block 1015-c may involve using a cluster technique to select k UEs for the group. Block 1015-d may involve using historical data regarding the UEs located within the area of interest to select k UEs for the group. The operation(s) at each of blocks 1015-a, 1015-b, 1015-c and 1015-d may be performed using the data collection module 615 described with reference to FIGS. 6-8.

After the selection of k UEs is completed at the block 1015-a, 1015-b, 1015-c or 1015-d specified by the selection criteria, the method 1000 may proceed to block 1020. At block 1020, actual usage data may be collected from the selected UEs. The data collection performed at block 1020 may be continuous or periodic, as appropriate or desired. Continuous data collection may be performed, for example, when the network has sufficient available bandwidth such that the data collection does not significantly adversely affect network performance (e.g., services provided to the UEs). Periodic data collection may be performed, for example, when the network has sufficient available bandwidth within a certain time frame on a recurring basis. The operation(s) at block 1020 also may be performed using the data collection module 615 described with reference to FIGS. 6-8.

At block 1025, the method 1000 may involve determining network conditions. This may involve monitoring network conditions and/or receiving updates on the conditions from the network. The operation(s) at block 1025 may be performed using the network conditions monitor module 850 described with reference to FIG. 8.

Then, at block 1030, the network conditions determined at block 1025 may be evaluated to determine whether a significant change has occurred. Such evaluation may involve aspects of the network conditions that may affect the continued representativeness of the selected group of UEs from which data is being collected. For example, the addition and/or subtraction of a certain number of UEs (especially subtraction of any of the selected UEs) may represent a significant change. Alternatively or additionally, movement of the UEs located within the area of interest (e.g., the coverage area of the base station) to different locations may represent a significant change. If no significant change is determined at block 1030, the method 1000 may return to block 1020 for further data collection as the selected UEs may still be considered to be representative. However, if a significant change is determined at block 1030, the method 1000 may return to block 1005, for example, to identify/determine potentially different criteria for selection of UEs for data collection and proceed to one of blocks 1015-a, 1015-b, 1015-c and 1015-d to reselect UEs for the group.

Thus, the method 1000 may provide for data collection from a group of mobile devices in an efficient manner. It should be noted that the method 1000 is just one implementation and that the operations of the method 1000 may be rearranged or otherwise modified such that other implementations are possible.

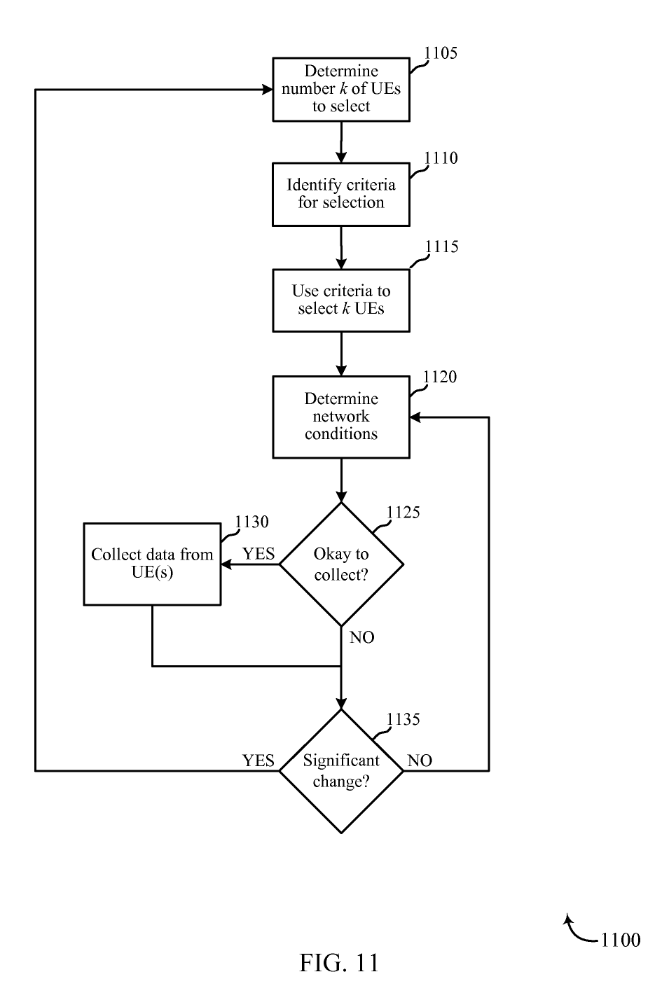

FIG. 11 is a flow chart illustrating yet another example of a method 1100 for wireless communication, in accordance with various aspects of the present disclosure. For clarity, the method 1100 is described below with reference to aspects of one or more of the base stations 105, 505 described with reference to FIGS. 1-5 and 8, and/or aspects of one or more of the devices 605 described with reference to FIGS. 6 and 7. In some examples, a base station may execute one or more sets of codes to control the functional elements of the base station to perform the functions described below. Additionally or alternatively, the base station may perform one or more of the functions described below using special-purpose hardware.

At block 1105, the method 1100 may involve determining a number k of UEs to select for data collection. At block 1110, criteria may be identified for selecting a statistically significant group of UEs devices from a plurality of UEs. The operation(s) at blocks 1105 and 1110 may be as described with reference to blocks 1005 and 1010, respectively, of the method 1000 of FIG. 10.

The method 1100 may proceed to block 1115, where the selection criteria identified at block 1110 may be used to select k UEs for the group. After the selection of k UEs is completed at the block 1115, the method 1100 may proceed to block 1120. At block 1120, network conditions may be determined. The operation(s) at block 1120 may be as described with reference to block 1025 of the method 1000 of FIG. 10.

Using the network conditions determined at block 1120, a determination may be made at block 1125 regarding whether the network conditions are suitable for data collection (e.g., sufficient available bandwidth). Thus, collection of data from the selected UEs may be performed opportunistically, such as to mitigate any adverse impact data collection may have on network performance and/or user experience at the UEs (especially the selected UEs). The determination made at block 1125 may be for all of the selected UEs or may be for individual selected UEs (e.g., on a per UE basis).

When the determination made at block 1125 is that it is okay to collect data from one or more of the selected UEs, the method 1100 may proceed to block 1130. At block 1130, actual usage data may be collected from the selected UEs. The data collection performed at block 1130 is opportunistic as dictated at block 1125. However, the determination made at block 1125 may be relatively continuous or periodic, or may be made as often as needed, for example, based at least in part on successful data collections from the selected UEs. The operation(s) at block 1130 also may be performed using the data collection module 615 described with reference to FIGS. 6-8.

The method 1100 may continue from block 1130 to block 1135, or jump to block 1135 from 1125 when network conditions are not suitable for data collection. At block 1135, the network conditions determined at block 1120 may be evaluated to determine whether a significant change has occurred. The operation(s) at block 1135 may be as described with reference to block 1030 of the method 1000 of FIG. 10.

If no significant change is determined at block 1135, the method 1100 may return to block 1020 to determine current (or most current available) network conditions and proceed with attempting data collection (e.g., blocks 1125 and 1130) from the selected UEs. However, if a significant change is determined at block 1135, the method 1100 may return to block 1105, for example, to identify/determine potentially different criteria for selection of UEs for data collection and proceed to block 1115 to reselect k UEs for the group.

Thus, the method 1100 may provide for data collection from a group of mobile devices in an efficient manner. It should be noted that the method 1100 is just one implementation and that the operations of the method 1000 may be rearranged or otherwise modified such that other implementations are possible.

In some examples, aspects from two or more of the methods 900, 1000 and 1100 may be combined. It should be noted that the methods 900, 1000 and 1100 are just example implementations, and that the operations of the methods 900-1100 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
identifying criteria for selecting a statistically significant group of mobile devices from a plurality of mobile devices;
selecting the statistically significant group in accordance with the criteria such that the statistically significant group is statistically representative of the plurality of mobile devices; and
collecting actual usage data from the mobile devices of the statistically significant group.

2. The method of claim 1, wherein identifying the criteria further comprises:
determining a number of mobile devices to select for the statistically significant group, the number of mobile devices determined based at least in part on available bandwidth.

3. The method of claim 1, wherein selecting the statistically significant group further comprises:
obtaining historical data of the plurality of mobile devices; and
selecting the statistically significant group based at least in part on the obtained historical data.

4. The method of claim 1, wherein identifying the criteria further comprises:
identifying that selection of the statistically significant group is to be at least partially random.

5. The method of claim 1, wherein identifying the criteria further comprises:
identifying that selection of the statistically significant group is to use a furthest-first picking procedure.

6. The method of claim 5, wherein selecting the statistically significant group comprises:
randomly selecting a first mobile device for the statistically significant group;
selecting a second mobile device for the statistically significant group that is furthest from the first mobile device; and
selecting a subsequent mobile device for the statistically significant group that is furthest from previously selected mobile devices including the first and second mobile devices.

7. The method of claim 5, wherein selecting the statistically significant group comprises:
applying the furthest-first picking procedure to a random subset of the plurality of mobile devices.

8. The method of claim 7, further comprising:
identifying the random subset to include a first number of mobile devices that is less than a total number of devices of the plurality of mobile devices and greater than a second number of mobile devices to be selected for the statistically significant group.

9. The method of claim 1, wherein selecting the statistically significant group comprises:
dividing the plurality of mobile devices into a number of clusters; and
selecting a mobile device nearest a center of each of the number of clusters for the statistically significant group.

10. The method of claim 1, wherein identifying the criteria further comprises:
identifying characteristics of the plurality of mobile devices.

11. The method of claim 1, wherein identifying the criteria further comprises:
identifying a variance of a metric among the plurality of mobile devices.

12. The method of claim 1, wherein collecting actual usage data from the mobile devices of the statistically significant group is performed continuously.

13. The method of claim 1, wherein collecting actual usage data from the mobile devices of the statistically significant group is performed opportunistically based at least in part on one or more of available bandwidth, current amount of network traffic, historical amount of network traffic, current status of individual mobile devices of the statistically significant group, historical status of individual mobile devices of the statistically significant group, or a signal parameter.

14. An apparatus for wireless communication, comprising:
means for identifying criteria for selecting a statistically significant group of mobile devices from a plurality of mobile devices;
means for selecting the statistically significant group in accordance with the criteria such that the statistically significant group is statistically representative of the plurality of mobile devices; and
means for collecting actual usage data from the mobile devices of the statistically significant group.

15. The apparatus of claim 14, wherein the means for identifying the criteria operates to determine a number of mobile devices to select for the statistically significant group, the number of mobile devices determined based at least in part on available bandwidth.

16. The apparatus of claim 14, wherein the means for selecting the statistically significant group operates to:
obtain historical data of the plurality of mobile devices; and
select the statistically significant group based at least in part on the obtained historical data.

17. The apparatus of claim 14, wherein the means for identifying the criteria operates to identify that selection of the statistically significant group is to be at least partially random.

18. The apparatus of claim 14, wherein the means for identifying the criteria operates to identify that selection of the statistically significant group is to use a furthest-first picking procedure.

19. The apparatus of claim 18, wherein the means for selecting the statistically significant group operates to:
randomly select a first mobile device for the statistically significant group;
select a second mobile device for the statistically significant group that is furthest from the first mobile device; and
select a subsequent mobile device for the statistically significant group that is furthest from previously selected mobile devices including the first and second mobile devices.

20. The apparatus of claim 18, wherein the means for selecting the statistically significant group operates to apply the furthest-first picking procedure to a random subset of the plurality of mobile devices.

21. The apparatus of claim 20, wherein the means for selecting the statistically significant group further operates to identify the random subset to include a first number of mobile devices that is less than a total number of devices of the plurality of mobile devices and greater than a second number of mobile devices to be selected for the statistically significant group.

22. The apparatus of claim 14, wherein the means for selecting the statistically significant group operates to:
divide the plurality of mobile devices into a number of clusters; and
select a mobile device nearest a center of each of the number of clusters for the statistically significant group.

23. The apparatus of claim 14, wherein the means for collecting actual usage data from the mobile devices of the statistically significant group operates to collect the data continuously.

24. The apparatus of claim 14, wherein the means for collecting actual usage data from the mobile devices of the statistically significant group operates to collect the data opportunistically based at least in part on one or more of available bandwidth, current amount of network traffic, historical amount of network traffic, current status of individual mobile devices of the statistically significant group, historical status of individual mobile devices of the statistically significant group, or a signal parameter.

25. An apparatus for wireless communication at a network device, comprising:
a processor;
memory in electronic communication with the processor; and
instructions stored in the memory, the instructions being executable by the processor to cause the network device to:
identify criteria for selecting a statistically significant group of mobile devices from a plurality of mobile devices;
select the statistically significant group in accordance with the criteria such that the statistically significant group is statistically representative of the plurality of mobile devices; and
collect actual usage data from the mobile devices of the statistically significant group.

26. The apparatus of claim 25, wherein the instructions are further executable by the processor to cause the network device to:
determine a number of mobile devices to select for the statistically significant group, the number of mobile devices determined based at least in part on available bandwidth.

27. The apparatus of claim 25, wherein the instructions are further executable by the processor to cause the network device to:
obtain historical data of the plurality of mobile devices; and
select the statistically significant group based at least in part on the obtained historical data; or
select the statistically significant group at least partially randomly; or select the statistically significant group using a furthest-first picking procedure.

28. The apparatus of claim 25, wherein the instructions to select the statistically significant group comprises instructions executable by the processor to cause the network device to:
divide the plurality of mobile devices into a number of clusters; and
select a mobile device nearest a center of each of the number of clusters for the statistically significant group.

29. The apparatus of claim 25, wherein the instructions to collect actual usage data from the mobile devices of the statistically significant group comprises instructions executable by the processor to cause the network device to:
collect actual usage data from the mobile devices of the statistically significant group continuously.

30. A non-transitory computer-readable medium storing code for communication at a network device, the code comprising instructions executable by a processor to cause the network device to:
identify criteria for selecting a statistically significant group of mobile devices from a plurality of mobile devices;
select the statistically significant group in accordance with the criteria such that the statistically significant group is statistically representative of the plurality of mobile devices; and
collect actual usage data from the mobile devices of the statistically significant group.
